(19) United States
(12) Patent Application Publication
(10) Pub. No.: US 2007/0011046 A1
(43) Pub. Date: Jan. 11, 2007

(54) Method of marketing

(76) Inventor: James William Dixon III, Woodstock, GA (US)

Correspondence Address: Eric R. Katz, 2007 Towne Lake Heights, Woodstock, GA, 30189, US

(21) Appl. No.: 11/178,776

(22) Filed: Jul. 11, 2005

(51) Int. Cl. G06Q 30/00

(52) U.S. Cl. 705/14

(57) ABSTRACT

A method of advertising or marketing to consumers of a business establishment or purchasers of a product requires consumers to obtain marketing or contest entry material at the business establishment or with the purchase of a product as part of a contest, promotion or consumer benefit program. The marketing material comprise a sheet material that can be inserted into a computer printer and, as part of the method, the consumer must then access a specific website on the Internet and upon completion of certain tasks is authorized to obtain authenticating indicia on the marketing material by placing the sheet-like marketing material in the computer printer so that the authenticating indicia is printed on the marketing material. The authenticate marketing material is then returned to qualify the consumer for certain benefits, such as entry into a contest or consumer benefit program.

### BACKGROUND OF THE INVENTION

1. Field of the Invention:

The present invention generally relates to a method of marketing utilizing marketing material made available to a consumer and a website on the Internet, and more particularly, to such a method wherein consumers obtain marketing material as part of a contest or consumer benefit program that requires the consumer to access a specific website on the Internet and obtain authenticating indicia for placement on the marketing material which is then returned or submitted by the consumer to qualify for contest prizes, gifts or other consumer benefits.

2. Background of the Invention:

Marketing methods are known that require the consumer to obtain entry forms for contests at a particular business establishment or with the purchase items in order to qualify for prizes to be won in such contests as well as obtain consumer benefits such as coupons, discounts, gifts or the like. In addition, disparate business establishments, such as movie producers and fast food restaurants, are known to collaborate to promote movies as well as increase food purchases at such restaurants. In these arrangements, the fast food restaurants often offer collector items, gifts or prizes related to a popular movie being marketed when a consumer purchase particular items, such as “happy meals,” at the restaurant. Moreover, it is known to provide coupons as well as gifts or prizes, with the purchase of a particular item, such as the “prize in every box” provided by the well know marketing campaign of CRACKERJACK™.

In addition to the foregoing, the proliferation of personal computers and their capacity to connect to the Internet has increased the ability of businesses to access their consumers as well make information available to or obtain information from such consumers. Corporations, manufacturers, advertisers, retailers, service providers, restaurants, movie studios and the like all have a need to provide consumers, potential consumers and the others with information about their products and companies as well as obtain marketing information useful in determining the interests of their consumers in new or existing products.

A method is known, such as disclosed by the Applicant of the present invention in U.S. Pat. No. 6,587,834, for promoting a website on the Internet which comprise, according to one embodiment thereof, the steps of: connecting a computer to the Internet at a specific address, the computer storing a website with information which the owner of the website desires to be accessed by the public and distributing an article of manufacture, such as, for example, a book, in incomplete form to a recipient. With the distribution of the article of manufacture, the address of the website being promoted is provided along with instructions directing the recipient of the incomplete article of manufacture to access the website at the specific address on the Internet to obtain the missing part of the article of manufacture. The recipient then accesses the website and views, downloads and/or prints out the missing part of the article of manufacture.

The above-noted patent is directed to increasing traffic on and attracting attention to the website being promoted by providing an incentive, i.e., book or article of manufacture, which is completed by accessing the website, but does not disclose or suggest a method of marketing as described and claimed by the present application.

### SUMMARY OF THE INVENTION

Accordingly, it is an object of the present invention to provide a new and useful method of marketing to a consumer that requires the consumer to access a website in order to receive consumer benefits.

Another object of the present invention is to provide a method of marketing that is relatively easy to use and permits the marketer to obtain from or provide information to a consumer as part of a promotion, contest or the like.

One particular advantageous feature of the present invention is that it provides an incentive to the consumer to provide or receive marketing information, product feedback or other valuable information to or from the business establishment which would otherwise not be obtained.

Yet another advantageous feature of the present invention is that it can be used in connection with the promotion of a certain product or service as an incentive to link the public to a specific website associated with the promoted product or service so that additional information and/or advertising is provided to the consumer regarding the promotion.

The present invention thus relates to a method of advertising or marketing to customers and potential customers of a business establishment or purchasers and potential purchasers of a product. According to one embodiment of the present invention, a consumer obtains marketing or contest entry material as part of a contest, promotion or consumer benefit program. The marketing material is obtained or made available to the consumer by any suitable means, such as, for example, by mail, at consumer request, at a business establishment or with the purchase of a product.

Typically the marketing material comprises any suitable material on which indicia can be written or printed, and includes, for example, awards, certificates, entry forms, maps, comic strips, liners, labels, menus, pages from books, shopping bags, other bags and the like. Moreover, the marketing material can take any form and may comprise any object as long as it can be written on. In this regard, the marketing material is not necessarily limited to a sheet like material, such as paper or the like that can be inserted into a printer, but also includes objects such as cups, glasses, dolls, toys or other tangible, non-sheet like objects that have at least a place on them on which authenticating indicia can be written, etched, applied or printed.

As part of the method, upon obtaining the marketing material, the consumer is instructed to access a specific website on the Internet. Upon completion of certain tasks dictated by the website, the consumer is permitted to obtain authenticating indicia which is handwritten, applied, etched or printed onto the marketing material. The authenticated contest marketing material is then submitted or presented by the consumer to qualify the consumer for certain benefits, such as entry into a contest or movie, free gifts, coupons, discounts or other consumer benefit program(s).

Thus, the present invention generally and broadly relates to a method of marketing to customers and potential customers of a business establishment or purchasers and potential purchasers of a product utilizing a website on the Internet in conjunction with marketing material obtained by the consumer. Consumers obtain the marketing material, for example, as part of a contest or other consumer benefit program. The marketing material is made available or otherwise distributed to consumers by any suitable means, for example, at a business establishment, by mail, upon request as well as, for example, with the purchase of a product. The market material instructs the consumer to access a specific website on the Internet to obtain authenticating indicia for placement on the marketing material to qualify the consumer for the desired consumer benefit(s). The marketing material, with the authenticating indicia thereon, is then submitted or presented by the consumer in order to receive the promised consumer benefit.

These and other objects, advantages, and features of the present invention are achieved by a method of marketing to a consumer comprises, according to one embodiment thereof, the steps of: providing marketing material to the consumer; requiring the consumer to access a specific website on the Internet to obtain indicia for placement on the marketing material to provide an authenticated marketing material; and requiring the consumer to present the authenticated marketing material in order to obtain a benefit for the consumer.

### BRIEF DESCRIPTION OF THE DRAWINGS

FIG. 1 is a block diagram of one embodiment of the method of the present invention; and

FIG. 2 is a block diagram of a further embodiment of the method of the present invention.

### DETAILED DESCRIPTION OF THE PREFERED EMBODIMENT(S)

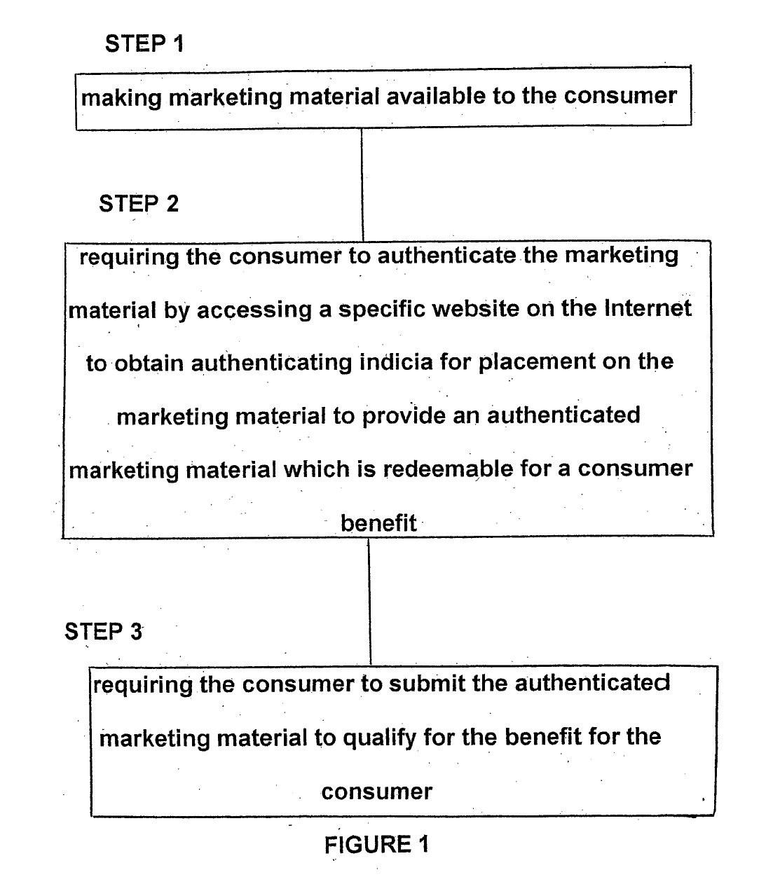

Referring to FIG. 1, one embodiment of a method of marketing to a consumer in accordance with the teachings of the present invention is illustrated wherein in Step 1 marketing material is made available or provided to the consumer. In that regard, the marketing material is made available or provided to the consumer, for example, at a business establishment, such as a restaurant, a movie theater, a retail store, a vending machine, newsstand or any other business establishment or location that the consumer visits. In addition, the marketing material can be made available or provided to the consumer, for example, with the purchase of a product, such as on or in the packaging in which the product is sold or handed to the consumer with the purchase of the item. Moreover, the marketing material can be made available to the consumer by any known means, such as for example, by mail or by placing them at a public kiosk or at the request of the consumer, such as by requiring the consumer to submit a request by mail in order to receive the marketing material. In addition, the marketing material can be made available at a movie theater or from any source which makes items available, such as in the newspaper, advertising circulars, and/or periodicals as well as at newsstands and vending machines.

The marketing material typically relates to the promotion of goods and services and comprises any suitable material on which indicia can be written, etched, printed or applied, and includes, for example, any article of manufacture such as, but not limited to awards, toys, apparel, cups, dishes, certificates, entry forms, maps, comic strips, liners, labels, menus, pages from books, advertisements, shopping bags, other bags and the like. Moreover, the marketing material can take any form and may comprise any object as long as it can be written on. In this regard, the marketing material is not necessarily limited to a sheet like material, such as paper or the like that can be inserted into a printer, but also includes objects such as cups, dolls, toys or other tangible, non-sheet like objects that have at least a place on them on which authenticating indicia can be written, etched, applied or printed.

Thus, the marketing material is preferable made of any material that the indicia can be written on or printed, which according to one embodiment comprises a sheet material, like paper or plastic, adapted for insertion into a computer printer so that indicia can be printed onto the marketing material. In that regard, if the marketing material is made available by a restaurant, it could be provided, for example, in the form of a placemat, menu or the like. If the marketing material is provided with a product such as a cereal or the like it could be provided, for example, as a printed portion of the cereal box which is cut out for insertion into the printer.

However, the foregoing is by way of example and in no way limiting in that the marketing material, in its broadest sense, is envisioned as comprises anything item on which the indicia can be applied, written, etched or printed and can be made available by any known means.

The marketing material is typically provided as part of promotion, such as to advertise a movie by a business operation of a disparate nature, such as a fast food restaurant. In addition, the marketing material is required in order to obtain a benefit for the consumer. The consumer benefit includes qualifying for a gift, prize, coupon or entry into a contest, for example, related to the item being promoted. In order to use the marketing material to obtain the consumer benefit, the marketing material must be marked with authenticating indicia which can only be obtained by accessing a particular website on the Internet. Thus, the marketing material includes instruction directing the consumer to access the website at a specific web address in order to obtain a consumer benefit.

In Step 2 of the method, the consumer is instructed to authenticate the marketing material by accessing a specific website on the Internet to obtain authenticating indicia which is printed, etched, written or applied to the marketing material, by, for example, using a computer peripheral such as a computer printer or handwritten onto the marketing material using any suitable writing utensil to provide the authenticated marketing material. The indicia comprise, for example, a symbol, logo, code number, a holographic image, password, combination of letters and numbers or secret word and the like.

Typically, the accessing of the website is accomplished using a personal computer have a plurality of input/output peripherals including a printer and a modem, which connects to the Internet to allow the computer to interface with the particular Internet website at the specific address delineate by the marketing material. The website includes information that the promoter of the marketing material desires to be accessed by the consumer. The consumer must successfully complete the required navigation of the website to obtain the authenticating indicia and/or permission to print, etch or make the authenticating indicia on the marketing material. In that regard, the authenticating indicia can be applied to the marketing material by writing or drawing the authenticating indicia onto the marketing material by hand using a writing utensil such as a pen or pencil or by using a printer connected to the personal computer and inserting the marketing material into the computer printer and printing the authenticating indicia onto the marketing material from the website. Alternatively, the authenticating indicia can be etched on the marketing material using a laser etching arrangement or printed out as a holographic label to be applied to the marketing material.

According to a further embodiment of the invention, in Step 3 of the method, the consumer then returns or submits the marketing material with the authenticating indicia on it to complete the process and qualify for the consumer benefit. In that regard, the consumer can redeem the marketing material for items or entry into a movie or amusement park, as well as the other consumer benefits already noted herein.

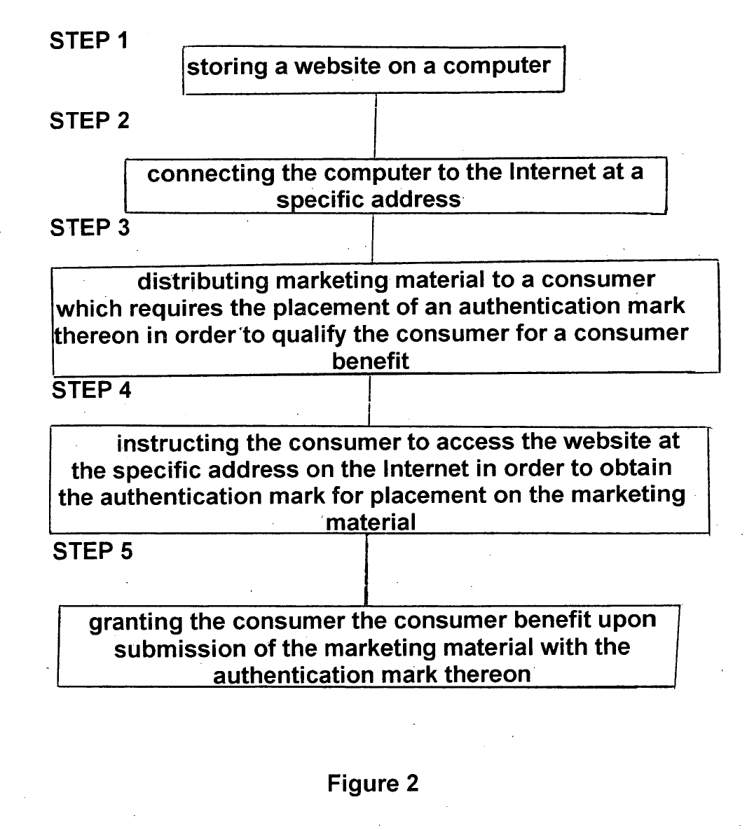

Referring to FIG. 2, a block diagram illustrates another embodiment of the method of marketing to a consumer of the present invention. In Step 1, a website is stored on a computer and in Step 2, the computer is connected to the Internet at a specific address. In Step 3, marketing material is distributed to a consumer which requires the placement of an authentication mark in order to qualify the consumer for consumer benefits as describe above. In Step 4, the consumer is instructed to access the website at the specific address on the Internet in order to obtain the authentication mark for placement on the marketing material to qualify for a consumer benefit. In a further embodiment, in Step 5, the consumer is granted a consumer benefit upon submission of the marketing material with the authentication mark thereon.

The promoter of the marketing material can have the consumer view certain information or advertising before the consumer is authorized to print the authenticating indicia onto the marketing material. In which case, the website is constructed in such a manner that the consumer must navigate through a series of different web pages containing the information or advertising that is desired to be viewed before arriving at the web page at which permission is granted to the print the authenticating indicia onto the marketing material.

In addition or alternatively, the promoter of the marketing material can have the consumer provide certain information before the consumer is authorized to obtain, make or print the authenticating indicia for placement on the marketing material. As a result, the website is constructed in such a manner that the consumer must answer a series of questions providing information to the promoter that could be use in present or further marketing campaigns before arriving at the web page at which permission is granted to the print the authenticating indicia onto the marketing material.

Although the present invention has been described in terms of specific exemplary embodiments, it will be appreciated that various modifications and alterations might be made by those skilled in the art without departing from the spirit and scope of the invention as specified in the following claims.

What is claimed is:

1. A method of marketing to a consumer, comprising the steps of:
making marketing material available to the consumer; and
requiring the consumer to authenticate the marketing material by accessing a specific website on the Internet to obtain authenticating indicia for placement on the marketing material to provide an authenticated marketing material which is redeemable for a consumer benefit.

2. A method according to claim 1, further comprising the step of: requiring the consumer to submit the authenticated marketing material to qualify for the benefit for the consumer.

3. A method according to claim 1, wherein the step of making the marketing material available comprises at least one of: making the marketing material available to the consumer at a business establishment and providing the marketing material with the purchase of an item by the consumer.

4. A method according to claim 1, wherein the marketing material is made of a material adapted to receive the authenticating indicia.

5. A method according to claim 1, wherein the authenticating indicia is handwritten, applied, etched or printed onto the marketing material.

6. A method according to claim 1, wherein the step of authenticating the marketing material further comprises the step of requiring the consumer to access at least one web page of the website having viewable information before being permitted to obtain the authenticating indicia for application to the marketing material.

7. A method according to claim 1, wherein the step of authenticating the marketing material further comprises the step of requiring the consumer to access at least one web page of the website and provide certain information before being permitted to obtain the authenticating indicia for application to the marketing material.

8. A method according to claim 1, wherein the consumer benefit includes at east one of qualifying the consumer for a contest; a discount, a coupon, a benefit point redemption plan and a gift.

9. A method according to claim 1, wherein the indicia comprises at least one of the following: a symbol, a logo, a code number, a holographic image, a password, a combination of letters and numbers or at least one secret word.

10. A method according to claim 1, wherein the marketing material is one of an award, a certificate, an entry form, a map, a comic strip, an advertisement, a coupon, a tray liner, a label, a menu, a page from a book, a shopping bag, a bag, a cup, a drinking glass, a doll, a toy, an article of manufacture, a placemat and part of a package of an item.

11. A method for marketing to a consumer comprising the steps of:
storing a website on a computer;
connecting the computer to the Internet at a specific address;
distributing marketing material to a consumer which requires the placement of an authentication mark thereon in order to qualify the consumer for a consumer benefit;
instructing the consumer to access the website at the specific address on the Internet in order to obtain the authentication mark for placement on the marketing material.

12. A method according to claim 11, further comprising the step of: granting the consumer the consumer benefit upon submission of the marketing material with the authentication mark thereon.

13. A method according to claim 11, wherein the step of distributing the marketing material comprises at least one of distributing the marketing material to the consumer for free, at a business establishment and including the marketing material with the purchase of an item by the consumer.

14. A method according to claim 11, wherein the marketing material is made of a material adapted to receive the authorization mark thereon.

15. A method according to claim 11, further comprising the step of requiring the consumer to access at least one web page of the website having viewable information before being permitted to obtain the authentication mark for placement on the marketing material.

16. A method according to claim 11, further comprises the step of requiring the consumer to access at least one web page of the website and provide certain information before being permitted to obtain the authentication mark for placement on the marketing material.

17. A method according to claim 11, wherein the consumer benefit includes at least one of qualifying the consumer for a contest; a discount, a coupon, a benefit point redemption plan and a gift.

18. A method according to claim 11, wherein the authentication mark is handwritten, applied, etched or printed onto the marketing material.

19. A method according to claim 18, wherein the authorization mark is at least oneof the following: a symbol, a logo, a code number, a holographic image, a password, a combination of letters and numbers or at least one secret word.

20. A method according to claim 18, wherein the marketing material is one of an award, a certificate, an entry form, a map, a comic strip, an advertisement, a p tray liner, a label, a menu, a page from a book, a shopping bag, a bag, a cup, a drinking glass, a doll, a toy, an article of manufacture, a placemat and part of a package of an item.
